(19) United States
(12) Patent Application Publication
(10) Pub. No.: US 2020/0003358 A1
(43) Pub. Date: Jan. 2, 2020

(54) Safety Supporting Frame Device and Supporting Frame Assembly

(71) Applicant: Dennis H. Wang, Baldwin Park, CA (US)

(72) Inventor: Dennis H. Wang, Baldwin Park, CA (US)

(21) Appl. No.: 16/021,082

(22) Filed: Jun. 28, 2018

(51) Int. Cl. F16M 11/20; F16M 11/04

(52) U.S. Cl. CPC F16M 11/20; B63B 2035/715; F16M 11/04

(57) ABSTRACT

A safety supporting frame device includes a first frame having first and second connecting portions. A second frame includes third and fourth connecting portions and is pivotable relative to the first frame between a folded position and an extended position. When the second frame is in the folded position, the third connecting portion is adjacent to the first connecting portion, and the fourth connecting portion is adjacent to the second connecting portion. When the second frame is in the extended position, the third connecting portion is distant to the first connecting portion, and the fourth connecting portion is distant to the second connecting portion. A first strap is fixed to the first and fourth connecting portions. A second strap is fixed to the second and third connecting portions. When the second frame is in the extended position, the first and second straps extend across and overlap each other.

### BACKGROUND OF THE INVENTION

The present invention relates to a safety supporting frame device and, more particularly, to a safety supporting frame device for supporting an article for water sports.

Taiwan Utility Model No. M311691 discloses a hanging device including ropes and hooks for hanging an article. When the hanging device is used to hang a canoe, each of the bow portion and the stern portion of the canoe are hung by two straps that could be subject to different forces due to the factors of the hanging position and the contour of the canoe. Specifically, a short strap or a strap hanging a wider portion of the canoe is subject to a larger force and is, thus, apt to break due to an uneven load, leading to falling of the canoe. Furthermore, the hanging device using the above hanging method occupies a large volume.

### BRIEF SUMMARY OF THE INVENTION

A safety supporting frame device according to the present invention includes a first frame including a first connecting portion, a second connecting portion, a first leg, and a second leg. A second frame includes a third connecting portion, a fourth connecting portion, a third leg, and a fourth leg. The second frame is pivotably connected to the first frame and is pivotable relative to the first frame between a folded position and an extended position. When the second frame is in the folded position, the third connecting portion is adjacent to the first connecting portion, the fourth connecting portion is adjacent to the second connecting portion, the third leg is adjacent to the first leg, and the fourth leg is adjacent to the second leg. When the second frame is in the extended position, the third connecting portion is distant to the first connecting portion, the fourth connecting portion is distant to the second connecting portion, the third leg is distant to the first leg, and the fourth leg is distant to the second leg. A supporting strap unit includes a first strap and a second strap. The first strap includes a first end fixed to the first connecting portion and a second end fixed to the fourth connecting portion. The second strap includes a first end fixed to the second connecting portion and a second end fixed to the third connecting portion. When the second frame is in the extended position, the first strap and the second strap extend across and overlap each other.

In an example, the first frame includes a first section, a second section, and a third section. The first section, the second section, and the third section are formed by bending an elongated member to form an integral monolithic structure. The second section is located between the first section and the third section. A first bend is formed between the first section and the second section. A second bend is formed between the second section and the third section. The first frame is U-shaped. The first connecting portion is located at an end of the second section adjacent to the first section. The second connecting portion is located at an end of the second section adjacent to the third section. The first leg is located at an end of the first section opposite to the second section. The second section is located at an end of the third section opposite to the second section. The second frame includes a fourth section, a fifth section, and a sixth section. The fourth section, the fifth section, and the sixth section are formed by bending an elongated member to form an integral monolithic structure. The fifth section is located between the fourth section and the sixth section. A third bend is formed between the fourth section and the fifth section. A fourth bend is formed between the fifth section and the sixth section. The second frame is U-shaped. An intermediate portion between two ends of the fourth section is pivotably connected to an intermediate portion between two ends of the first section. An intermediate portion between two ends of the sixth section is pivotably connected to an intermediate portion between two ends of the third section. The third connecting portion is located at an end of the fifth section adjacent to the fourth section. The fourth connecting portion is located at an end of the fifth section adjacent to the sixth section. The third leg is located at an end of the fourth section opposite to the fifth section. The fourth leg is located at an end of the sixth section opposite to the fifth section.

In an example, the first frame includes a fifth connecting portion at the second section. The fifth connecting portion is located between the first connecting portion and the second connecting portion. The second frame includes a sixth connecting portion at the fifth section. The sixth connecting portion is located between the third connecting portion and the fourth connecting portion. The supporting strap unit includes a first buckle strap and a second buckle strap. The first buckle strap includes a first end fixed to the fifth connecting portion and a second end having a first buckle. The second buckle strap includes a first end fixed to the sixth connecting portion and a second end having a second buckle. The second buckle is detachably coupled to the first buckle.

In another example, the first connecting portion includes a first top seat. The second connecting portion includes a second top seat. The first leg includes a first bottom seat. The second leg includes a second bottom seat. The first frame includes a first rod, a second rod, a third rod, and a fourth rod. The first rod and the second rod are X-hinged to each other. The first rod includes a first end pivotably connected to the first top seat and a second end pivotably connected to the second bottom seat. The second rod includes a first end pivotably connected to the second top seat and a second end pivotably connected to the first bottom seat. The third connecting portion includes a third top seat. The fourth connecting portion includes a fourth top seat. The third leg includes a third bottom seat. The fourth leg includes a fourth bottom seat. The second frame includes a fifth rod, a sixth rod, a seventh rod, and an eighth rod. The fifth rod and the sixth rod are X-hinged to each other. The fifth rod includes a first end pivotably connected to the third top seat and a second end pivotably connected to the fourth bottom seat. The sixth rod includes a first end pivotably connected to the fourth top seat and a second end pivotably connected to the third bottom seat. The third rod and the seventh rod are X-hinged to each other. The third rod includes a first end pivotably connected to the first bottom seat and a second end pivotably connected to the third bottom seat. The seventh rod includes a first end pivotably connected to the third top seat and a second end pivotably connected to the first bottom seat. The fourth rod and the eighth rod are X-hinged to each other. The fourth rod includes a first end pivotably connected to the second top seat and a second end pivotably connected to the fourth bottom seat. The eighth rod includes a first end pivotably connected to the fourth top seat and a second end pivotably connected to the second bottom seat. The first strap includes a first end fixed to the first top seat and a second end fixed to the fourth top seat. The second strap includes a first end fixed to the second top seat and a second end fixed to the third top seat.

In an example, the supporting strap unit includes a first buckle strap and a second buckle strap. The first buckle strap includes a first end fixed to the first top seat and a second end having a first buckle. The second buckle strap includes a first end fixed to the third top seat and a second end having a second buckle. The second buckle is detachably coupled to the first buckle.

A supporting frame assembly according to the present invention includes two safety supporting frame devices mentioned above to provide enhanced stability and enhanced safety for supporting an article for water sports.

The present invention will become clearer in light of the following detailed description of illustrative embodiments of this invention described in connection with the drawings.

### DESCRIPTION OF THE DRAWINGS

FIG. 1 is a perspective view of a safety supporting frame device of a first embodiment according to the present invention in a folded position.

FIG. 2 is a perspective view of the safety supporting frame device of FIG. 1 in an extended position.

FIG. 3 is a perspective view illustrating use of two safety supporting frame devices of FIG. 2 for supporting a canoe.

FIG. 4 is an enlarged view of a portion of the canoe and one of the two safety supporting frame devices of FIG. 3.

FIG. 5 is a perspective view of a safety supporting frame device of a second embodiment according to the present invention in a folded position.

FIG. 6 is a perspective view of the safety supporting frame device of FIG. 5 in an extended position.

FIG. 7 is a perspective view illustrating use of two safety supporting frame devices of FIG. 6 for supporting a canoe.

### DETAILED DESCRIPTION OF THE INVENTION

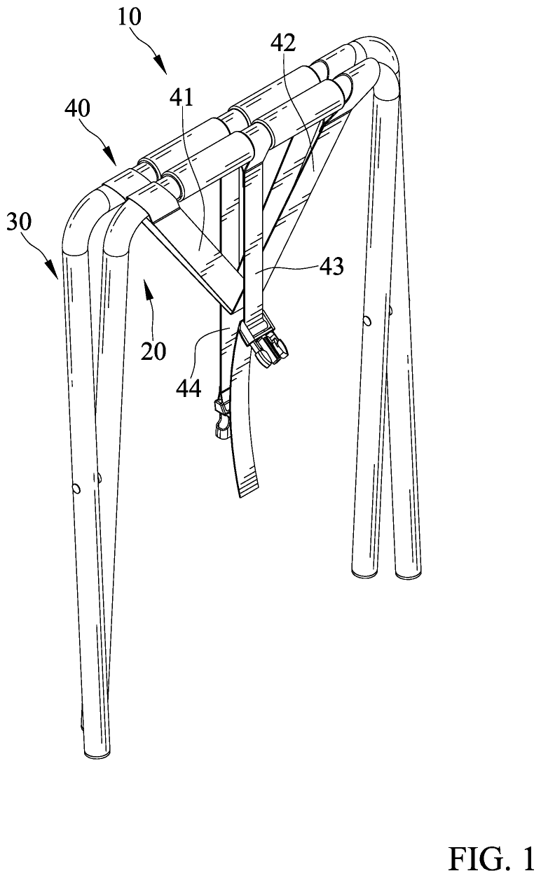

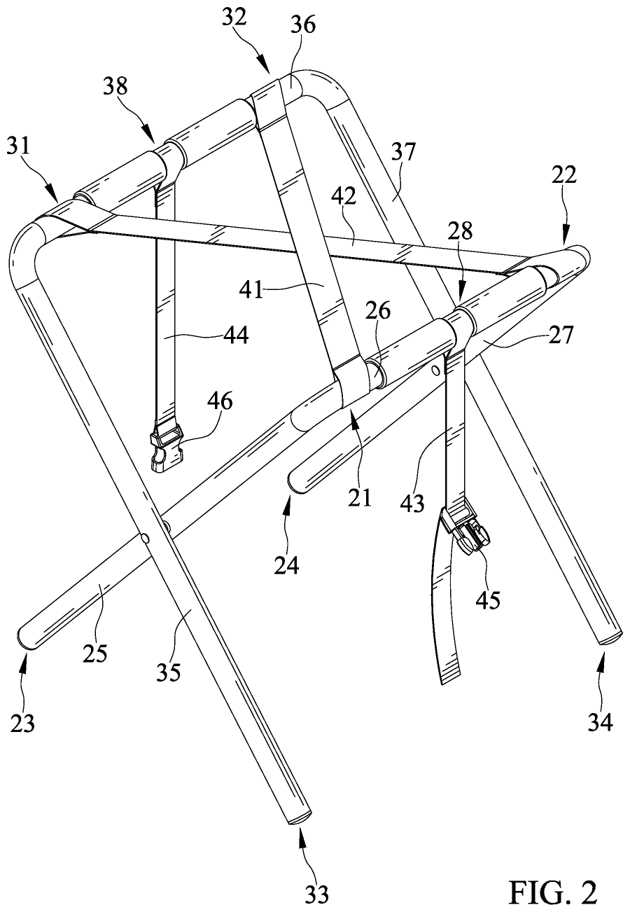

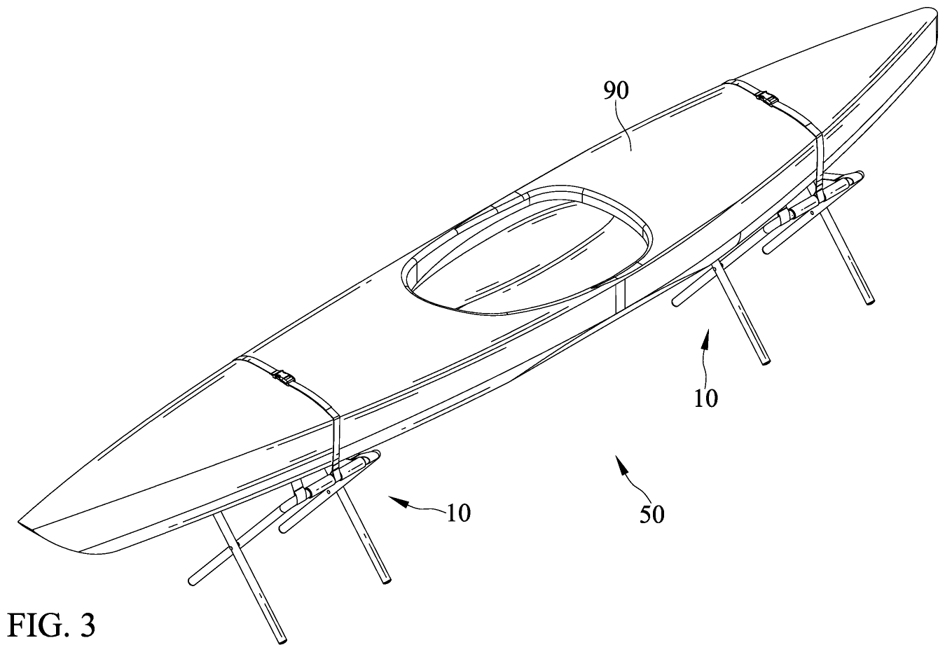

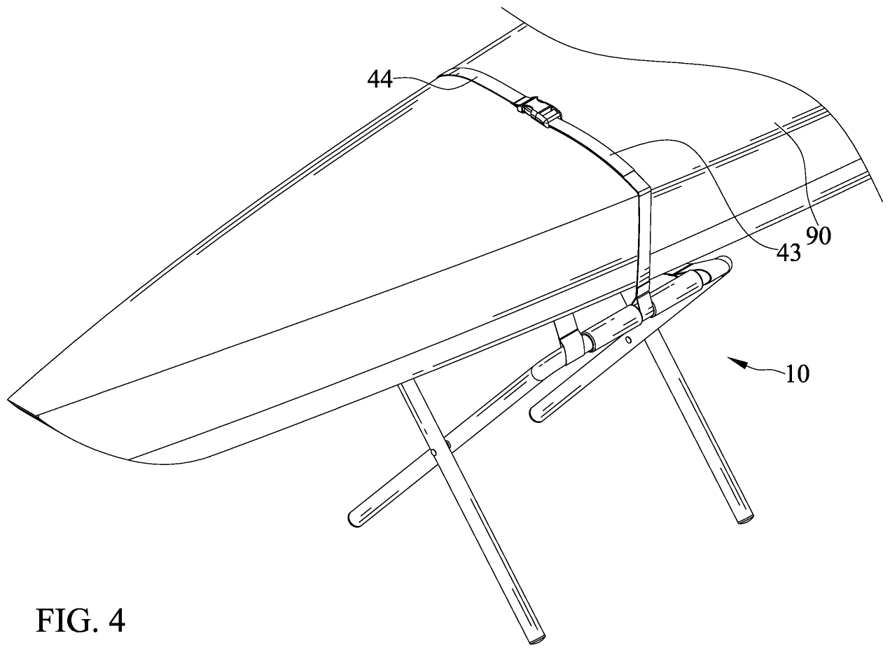

With reference to FIGS. 1-4, a safety supporting frame device 10 of a first embodiment according to the present invention includes a first frame 20, a second frame 30, and a supporting strap unit 40. A supporting frame assembly 50 according to the present invention includes two safety supporting frame devices 10.

The first frame 20 includes a first connecting portion 21, a second connecting portion 22, a first leg 23, and a second leg 24. The first frame 20 includes a first section 25, a second section 26, and a third section 27. The first section 25, the second section 26, and the third section 27 are formed by bending an elongated member to form an integral monolithic structure. The second section 26 is located between the first section 25 and the third section 27. A first bend is formed between the first section 25 and the second section 26. A second bend is formed between the second section 26 and the third section 27. The first frame 20 is U-shaped.

The second frame 30 includes a third connecting portion 31, a fourth connecting portion 32, a third leg 33, and a fourth leg 34. The second frame 30 is pivotably connected to the first frame 20 and is pivotable relative to the first frame 20 between a folded position and an extended position. When the second frame 30 is in the folded position, the third connecting portion 31 is adjacent to the first connecting portion 21, the fourth connecting portion 32 is adjacent to the second connecting portion 22, and the third leg 33 is adjacent to the first leg 23, and the fourth leg 34 is adjacent to the second leg 24. When the second frame 30 is in the extended position, the third connecting portion 31 is distant to the first connecting portion 21, the fourth connecting portion 32 is distant to the second connecting portion 22, the third leg 33 is distant to the first leg 23, and the fourth leg 34 is distant to the second leg 24.

The second frame 30 includes a fourth section 35, a fifth section 36, and a sixth section 37. The fourth section 35, the fifth section 36, and the sixth section 37 are formed by bending an elongated member to form an integral monolithic structure. The fifth section 36 is located between the fourth section 35 and the sixth section 37. A third bend is formed between the fourth section 35 and the fifth section 36. A fourth bend is formed between the fifth section 36 and the sixth section 37. The second frame 30 is U-shaped. An intermediate portion between two ends of the fourth section 35 is pivotably connected to an intermediate portion between two ends of the first section 25. An intermediate portion between two ends of the sixth section 37 is pivotably connected to an intermediate portion between two ends of the third section 27.

The third connecting portion 31 is located at an end of the fifth section 36 adjacent to the fourth section 35. The fourth connecting portion 32 is located at an end of the fifth section 36 adjacent to the sixth section 37. The third leg 33 is located at an end of the fourth section 35 opposite to the fifth section 36. The fourth leg 34 is located at an end of the sixth section 37 opposite to the fifth section 36.

The first frame 20 includes a fifth connecting portion 28 at the second section 26. The fifth connecting portion 28 is located between the first connecting portion 21 and the second connecting portion 22. The second frame 30 includes a sixth connecting portion 38 at the fifth section 36. The sixth connecting portion 38 is located between the third connecting portion 31 and the fourth connecting portion 32.

The supporting strap unit 40 including a first strap 41 and a second strap 42. The first strap 41 includes a first end fixed to the first connecting portion 21 and a second end fixed to the fourth connecting portion 32. The second strap 42 includes a first end fixed to the second connecting portion 22 and a second end fixed to the third connecting portion 31. When the second frame 30 is in the extended position, the first strap 41 and the second strap 42 extend across and overlap each other.

The supporting strap unit 40 includes a first buckle strap 43 and a second buckle strap 44. The first buckle strap 43 includes a first end fixed to the fifth connecting portion 28 and a second end having a first buckle 45. The second buckle strap 44 includes a first end fixed to the sixth connecting portion 38 and a second end having a second buckle 46. The second buckle 46 is detachably coupled to the first buckle 45.

The supporting frame assembly 50 can be used to support various articles for water sports, such as a paddle board, a stand-up paddle board, a canoe, a surf board, a kayak, a rowboat, etc. Furthermore, the supporting frame assembly 50 can be applied to articles for water sports having various bottom shapes. In use of the supporting frame assembly 50, two safety supporting frame devices 10 are placed on the ground and spaced from each other. A canoe 90 can be placed on the two supporting frame devices 10. The first buckle strap 43 and the second buckle strap 44 can be wound around the canoe 90, and the first buckle 45 is coupled with the second buckle 46.

Since the first strap 41 and the second strap 42 extend across each other, the canoe 90 placed on the safety supporting frame devices 10 simultaneously press the first strap 41 and the second strap 42 of each safety supporting frame device 10. Thus, the weight of the canoe 90 is effectively distributed to avoid breakage of the first strap 41 and the second strap 42 resulting from excessively large pulling forces. Furthermore, the canoe 90 is securely fixed by the first strap 43 and the second strap 44 to avoid falling of the canoe 90, enhancing the stability and safety of the safety supporting frame device 10.

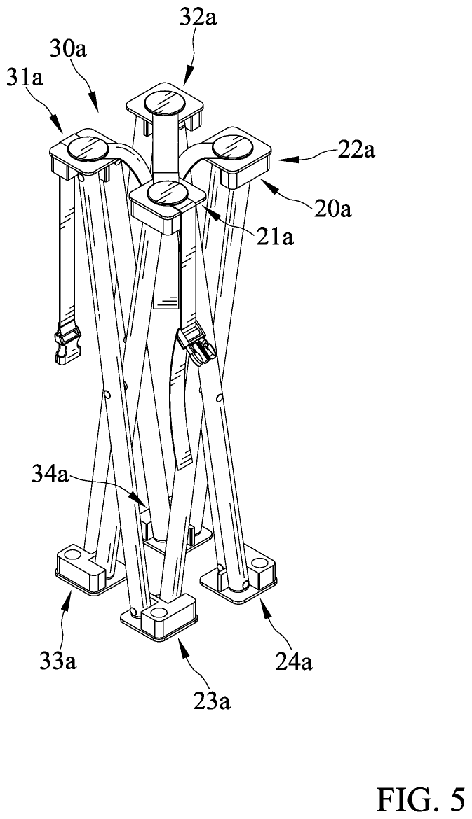

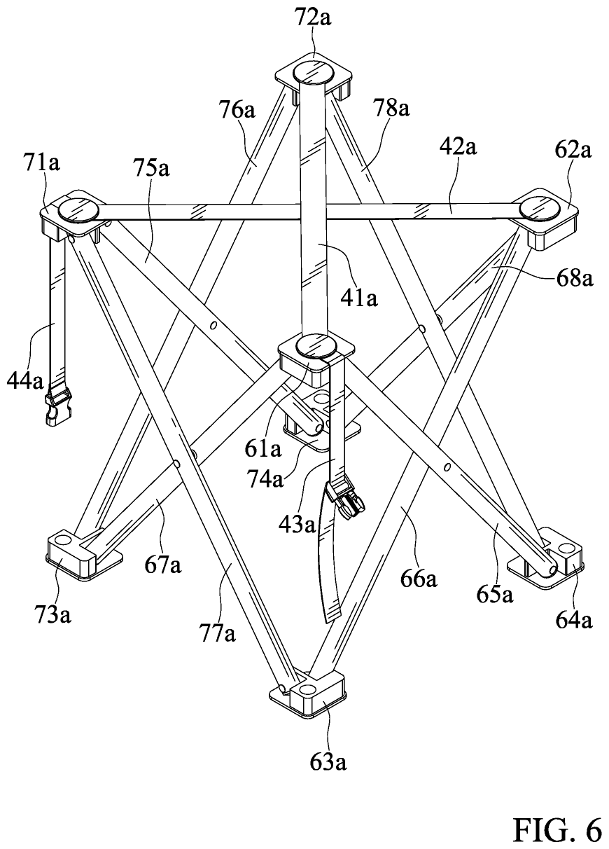

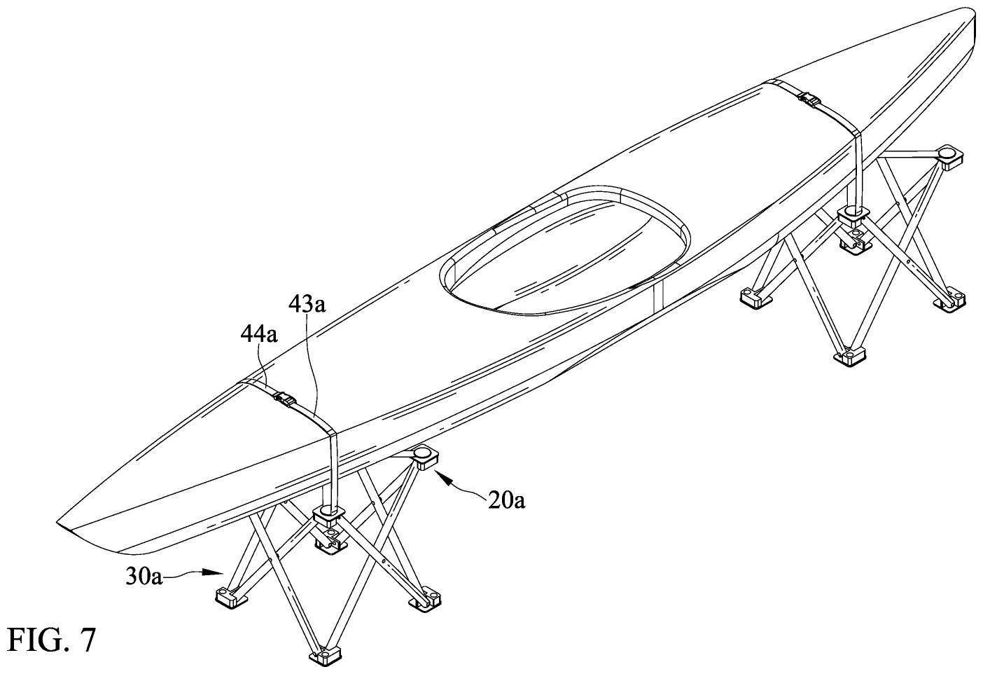

FIGS. 5-7 show a safety supporting frame device of a second embodiment according to the present invention substantially the same as the first embodiment. The second embodiment is different from the first embodiment by that the first connecting portion 21a includes a first top seat 61a, the second connecting portion 22a includes a second top seat 62a, the first leg 23a includes a first bottom seat 63a, and the second leg 24a includes a second bottom seat 64a. Furthermore, the first frame 20a includes a first rod 65a, a second rod 66a, a third rod 67a, and a fourth rod 68a. The first rod 65a and the second rod 66a are X-hinged to each other. The first rod 65a includes a first end pivotably connected to the first top seat 61a and a second end pivotably connected to the second bottom seat 64a. The second rod 66a includes a first end pivotably connected to the second top seat 62a and a second end pivotably connected to the first bottom seat 63a.

The third connecting portion 31a includes a third top seat 71a. The fourth connecting portion 32a includes a fourth top seat 72a. The third leg 33a includes a third bottom seat 73a. The fourth leg 34a includes a fourth bottom seat 74a. The second frame 30a includes a fifth rod 75a, a sixth rod 76a, a seventh rod 77a, and an eighth rod 78a. The fifth rod 75a and the sixth rod 76a are X-hinged to each other. The fifth rod 75a includes a first end pivotably connected to the third top seat 71a and a second end pivotably connected to the fourth bottom seat 74a. The sixth rod 76a includes a first end pivotably connected to the fourth top seat 72a and a second end pivotably connected to the third bottom seat 73a.

The third rod 67a and the seventh rod 77a are X-hinged to each other. The third rod 67a includes a first end pivotably connected to the first bottom seat 61a and a second end pivotably connected to the third bottom seat 73a. The seventh rod 77a includes a first end pivotably connected to the third top seat 71a and a second end pivotably connected to the first bottom seat 63a. The fourth rod 68a and the eighth rod 78a are X-hinged to each other. The fourth rod 68a includes a first end pivotably connected to the second top seat 62a and a second end pivotably connected to the fourth bottom seat 74a. The eighth rod 78a includes a first end pivotably connected to the fourth top seat 72a and a second end pivotably connected to the second bottom seat 64a.

The first strap 41a includes a first end fixed to the first top seat 61a and a second end fixed to the fourth top seat 72a. The second strap 42a includes a first end fixed to the second top seat 62a and a second end fixed to the third top seat 71a. The first buckle strap 43a is fixed to the first top seat 61a. The second buckle strap 44a is fixed to the third top seat 71a.

By the arrangement of the safety supporting frame device 10 according to the present invention, when the second frame 30 is in the extended position, the first strap 41 and the second strap 42 extend across and overlap each other. The weight of the article supported by the supporting frame assembly 50 according to the present invention can be evenly distributed to provide enhanced stability and enhanced safety.

Although specific embodiments have been illustrated and described, numerous modifications and variations are still possible without departing from the scope of the invention. The scope of the invention is limited by the accompanying claims.

1. A safety supporting frame device comprising:
a first frame including a first connecting portion, a second connecting portion, a first leg, and a second leg;
a second frame including a third connecting portion, a fourth connecting portion, a third leg, and a fourth leg, the second frame is pivotably connected to the first frame and is pivotable relative to the first frame between a folded position and an extended position, wherein when the second frame is in the folded position, the third connecting portion is adjacent to the first connecting portion, the fourth connecting portion is adjacent to the second connecting portion, the third leg is adjacent to the first leg, and the fourth leg is adjacent to the second leg, wherein when the second frame is in the extended position, the third connecting portion is distant to the first connecting portion, the fourth connecting portion is distant to the second connecting portion, the third leg is distant to the first leg, and the fourth leg is distant to the second leg, and
a supporting strap unit including a first strap and a second strap, wherein the first strap includes a first end fixed to the first connecting portion and a second end fixed to the fourth connecting portion, wherein the second strap includes a first end fixed to the second connecting portion and a second end fixed to the third connecting portion, and wherein when the second frame is in the extended position, the first strap and the second strap extend across and overlap each other;
wherein the first frame includes a fifth connecting portion located between the first connecting portion and the second connecting portion, wherein the second frame includes a sixth connecting portion located between the third connecting portion and the fourth connecting portion,
wherein the supporting strap unit further includes a first buckle strap and a second buckle strap, wherein the first buckle strap includes a first end fixed to the fifth connecting portion and a second end having a first buckle, wherein the second buckle strap includes a first end fixed to the sixth connecting portion and a second end having a second buckle, and wherein the second buckle is detachably coupled to the first buckle.

2. The safety supporting frame device as claimed in claim 1, wherein the first frame includes a first section, a second section, and a third section, wherein the first section, the second section, and the third section are formed by bending an elongated member to form an integral monolithic structure, wherein the second section is located between the first section and the third section, wherein a first bend is formed between the first section and the second section, wherein a second bend is formed between the second section and the third section, wherein the first frame is U-shaped,
wherein the first connecting portion is located at an end of the second section adjacent to the first section, wherein the second connecting portion is located at an end of the second section adjacent to the third section, wherein the first leg is located at an end of the first section opposite to the second section, wherein the second section is located at an end of the third section opposite to the second section,
wherein the second frame includes a fourth section, a fifth section, and a sixth section, wherein the fourth section, the fifth section, and the sixth section are formed by bending an elongated member to form an integral monolithic structure, wherein the fifth section is located between the fourth section and the sixth section, wherein a third bend is formed between the fourth section and the fifth section, wherein a fourth bend is formed between the fifth section and the sixth section, wherein the second frame is U-shaped,
wherein an intermediate portion between two ends of the fourth section is pivotably connected to an intermediate portion between two ends of the first section, wherein an intermediate portion between two ends of the sixth section is pivotably connected to an intermediate portion between two ends of the third section,
wherein the third connecting portion is located at an end of the fifth section adjacent to the fourth section, wherein the fourth connecting portion is located at an end of the fifth section adjacent to the sixth section, wherein the third leg is located at an end of the fourth section opposite to the fifth section, wherein the fourth leg is located at an end of the sixth section opposite to the fifth section.

3. The safety supporting frame device as claimed in claim 2, wherein the fifth connecting portion is disposed at the second section, and wherein the sixth connecting portion is disposed at the fifth section.

4. The safety supporting frame device as claimed in claim 1, wherein the first connecting portion includes a first top seat, wherein the second connecting portion includes a second top seat, wherein the first leg includes a first bottom seat, wherein the second leg includes a second bottom seat,
wherein the first frame includes a first rod, a second rod, a third rod, and a fourth rod, wherein the first rod and the second rod are X-hinged to each other, wherein the first rod includes a first end pivotably connected to the first top seat and a second end pivotably connected to the second bottom seat, wherein the second rod includes a first end pivotably connected to the second top seat and a second end pivotably connected to the first bottom seat,
wherein the third connecting portion includes a third top seat, wherein the fourth connecting portion includes a fourth top seat, wherein the third leg includes a third bottom seat, wherein the fourth leg includes a fourth bottom seat,
wherein the second frame includes a fifth rod, a sixth rod, a seventh rod, and an eighth rod, wherein the fifth rod and the sixth rod are X-hinged to each other, wherein the fifth rod includes a first end pivotably connected to the third top seat and a second end pivotably connected to the fourth bottom seat, wherein the sixth rod includes a first end pivotably connected to the fourth top seat and a second end pivotably connected to the third bottom seat,
wherein the third rod and the seventh rod are X-hinged to each other, wherein the third rod includes a first end pivotably connected to the first bottom seat and a second end pivotably connected to the third bottom seat, wherein the seventh rod includes a first end pivotably connected to the third top seat and a second end pivotably connected to the first bottom seat,
wherein the fourth rod and the eighth rod are X-hinged to each other, wherein the fourth rod includes a first end pivotably connected to the second top seat and a second end pivotably connected to the fourth bottom seat, wherein the eighth rod includes a first end pivotably connected to the fourth top seat and a second end pivotably connected to the second bottom seat,
wherein the first strap includes a first end fixed to the first top seat and a second end fixed to the fourth top seat, wherein the second strap includes a first end fixed to the second top seat and a second end fixed to the third top seat.

5. The safety supporting frame device as claimed in claim 4, wherein the supporting strap unit includes a first buckle strap and a second buckle strap, wherein the first buckle strap includes a first end fixed to the first top seat and a second end having a first buckle, wherein the second buckle strap includes a first end fixed to the third top seat and a second end having a second buckle, and wherein the second buckle is detachably coupled to the first buckle.

6. A supporting frame assembly comprising two safety supporting frame devices, wherein each of the two safety supporting frame devices comprising:
a first frame including a first connecting portion, a second connecting portion, a first leg, and a second leg;
a second frame including a third connecting portion, a fourth connecting portion, a third leg, and a fourth leg, the second frame is pivotably connected to the first frame and is pivotable relative to the first frame between a folded position and an extended position, wherein when the second frame is in the folded position, the third connecting portion is adjacent to the first connecting portion, the fourth connecting portion is adjacent to the second connecting portion, the third leg is adjacent to the first leg, and the fourth leg is adjacent to the second leg, wherein when the second frame is in the extended position, the third connecting portion is distant to the first connecting portion, the fourth connecting portion is distant to the second connecting portion, the third leg is distant to the first leg, and the fourth leg is distant to the second leg, and
a supporting strap unit including a first strap and a second strap, wherein the first strap includes a first end fixed to the first connecting portion and a second end fixed to the fourth connecting portion, wherein the second strap includes a first end fixed to the second connecting portion and a second end fixed to the third connecting portion, and wherein when the second frame is in the extended position, the first strap and the second strap extend across and overlap each other;
wherein the first frame includes a fifth connecting portion located between the first connecting portion and the second connecting portion, wherein the second frame includes a sixth connecting portion located between the third connecting portion and the fourth connecting portion, wherein the supporting strap unit includes a first buckle strap and a second buckle strap, wherein the first buckle strap includes a first end fixed to the fifth connecting portion and a second end having a first buckle, wherein the second buckle strap includes a first end fixed to the sixth connecting portion and a second end having a second buckle, and wherein the second buckle is detachably coupled to the first buckle.
